(19) United States
(12) Patent Application Publication
(10) Pub. No.: US 2017/0032052 A1
(43) Pub. Date: Feb. 2, 2017

(54) GRAPH DATA PROCESSING SYSTEM THAT SUPPORTS AUTOMATIC DATA MODEL CONVERSION FROM RESOURCE DESCRIPTION FRAMEWORK TO PROPERTY GRAPH

(71) Applicant: Oracle International Corporation, Redwood Shores, CA (US)

(72) Inventors: RAGHAVAN RAMAN, San Jose, CA (US); SUNGPACK HONG, Palo Alto, CA (US); HASSAN CHAFI, San Mateo, CA (US)

(21) Appl. No.: 14/812,819

(22) Filed: Jul. 29, 2015

(51) Int. Cl. G06F 17/30

(52) U.S. Cl. CPC G06F 17/30958; G06F 17/30604

(57) ABSTRACT

A graph processing system that supports automatic data model conversion from Resource Framework Description (RDF) to Property Graph (PG) is provided. Rather than using a naive conversion approach that creates PG nodes and edges without properties, a set of conversion rules is evaluated to automatically convert RDF triples into PG nodes and edges with properties, as appropriate. Accordingly, the converted PG data takes full advantage of the PG format while advantageously avoiding the creation of extraneous nodes and edges, allowing queries on the PG data to be efficiently executed on any database supporting the PG data model. The plurality of rules categorize each triple into three different cases depending on whether or not the predicate is “rdf:type” and whether or not the object is a literal value, generating graph entities as appropriate for each case. Optionally, user defined rules may override the automatic rules.

### FIELD OF THE INVENTION

The present disclosure relates to graph data, and more specifically, to a graph data processing system that supports automatic data model conversion from Resource Description Framework (RDF) to Property Graph (PG).

### BACKGROUND

A database is an organized collection of data. The data is typically organized to model relevant aspects of reality in a way that supports processes requiring this information. A database model is a type of data model that determines the logical structure of a database and fundamentally determines in which manner data can be stored, organized, and manipulated. The most popular example of a database model is the relational model, which uses a table-based format.

However, in recent years, alternative database models, including graph data models, have gained in popularity. By storing data in a graph format that does not require adherence to a rigid structure such as a database schema of a relational database, greater scalability can be realized by collecting and processing such data on highly parallel multi-node clusters. Thus, databases based on graph data models can be particularly suited for big data applications that need to process large quantities of unstructured data and/or report results in real-time.

Resource Description Framework (RDF) is one such graph data model, which was originally designed to represent information about resources on the World Wide Web. Data stored using RDF describes a relationship (or edge) between two endpoints (or nodes), which are identified by Uniform Resource Identifiers (URIs). A URI includes a prefix that may refer to an electronic location on the Internet, or may refer to a namespace within a database system. Besides URIs, blank nodes (anonymous nodes) and literal values are also possible. Thus, RDF data can be represented as triplets: a subject (first endpoint), a predicate (relationship), and an object (second endpoint). Due to the simplicity of the RDF model, it has become one popular way to model data as a graph.

Property Graph (PG) is another graph data model. Unlike the RDF model, the PG model allows both nodes (vertices) and edges to have any number of arbitrary properties. Typically, these properties are represented by maps of key-value pairs.

While both RDF and PG models have their own advantages and disadvantages, there are significant differences between database systems that are based on different graph data models. For example, RDF model based databases tend to provide more query features focusing on data inference, whereas PG model based databases tend to provide more query features focusing on data analytics. Given the differing feature support between the different databases, it would be useful to have a way to convert graph data between formats to leverage features from different database systems.

While a straightforward conversion from RDF to PG is possible by naively converting every RDF subject and every RDF object into a PG node and converting every RDF predicate into a PG edge, this naive conversion process produces a PG that is much larger than necessary. As a result, queries on this converted PG data will be less than optimal, incurring much longer execution times. This reduced database performance may prevent database administrators from effectively leveraging all the features available from alternative database systems.

Based on the foregoing, there is a need for a method to easily convert graph data from one graph data format to another while preserving database performance on the converted data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that depicts an example graph processing system that supports automatic data model conversion from Resource Framework Description (RDF) to Property Graph (PG), according to an embodiment;

FIG. 2A is a block diagram that depicts a process for automatic data model conversion from RDF to PG, according to an embodiment;

FIG. 2B is a block diagram that depicts a plurality of rules for automatic data model conversion from RDF to PG, according to an embodiment;

FIG. 3 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

In an embodiment, a graph processing system that supports automatic data model conversion from Resource Framework Description (RDF) to Property Graph (PG) is provided. Rather than using a naive conversion approach that creates PG nodes and edges without properties, a set of conversion rules is evaluated to automatically convert RDF triples into PG nodes with properties and PG edges with properties, as appropriate. Accordingly, the converted PG data takes full advantage of the PG format while advantageously avoiding the creation of extraneous nodes and edges, thereby enabling queries on the PG data to be efficiently executed in a high performance manner on any database supporting the PG data model.

To proceed with the automated conversion, for each RDF triple, which includes a subject, a predicate, and an object, a set of automatic conversion rules is evaluated to determine which nodes to create (if any), which edges to create (if any), and which properties to associate with the nodes and edges, when appropriate. The automatic conversion rules may be optionally overridden by one or more user defined rules to provide greater flexibility in the conversion process. By following these rules, each RDF triple can be automatically converted into appropriate graph entities to create the converted PG data.

### System Overview

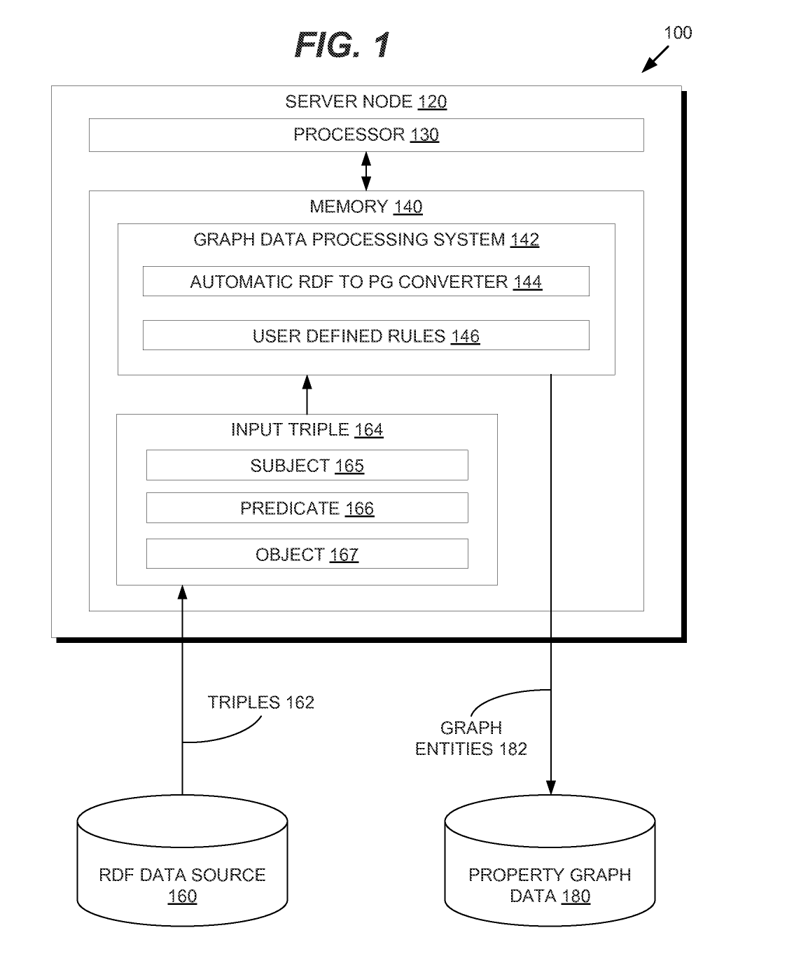

FIG. 1 is a block diagram that depicts an example graph processing system that supports automatic data model conversion from Resource Framework Description (RDF) to Property Graph (PG), according to an embodiment. System 100 of FIG. 1 includes server node 120, RDF data source 160, triples 162, Property Graph (PG) data 180, and graph entities 182. Server node 120 includes processor 130 and memory 140. Memory 140 includes graph data processing system 142. Graph data processing system 142 includes automatic RDF to PG converter 144, user defined rules 146, and input triple 164. Input triple 164 includes subject 165, predicate 166, and object 167.

As shown in FIG. 1, a server node 120 is configured to execute graph data processing system 142 using processor 130 and memory 140. By using a set of automatic conversion rules as described above, automatic RDF to PG converter 144 of graph data processing system 142 can process each of triples 162 from RDF data source 160 to generate appropriate graph entities 182 for storing as Property Graph (PG) data 180. As shown in input triple 164, each of triples 162 includes a subject 165, a predicate 166, and an object 167. Graph entities 182 may include nodes (vertexes), edges, and properties on both the nodes and the edges. Optionally, user defined rules 146 may be used to override the rules of automatic RDF to PG converter 144. After PG data 180 is generated, then a database management system supporting a PG data model may load PG data 180 to execute analytic queries or perform other tasks that may be difficult for a database management system that only supports a RDF graph data model.

### Graph Data Conversion Process

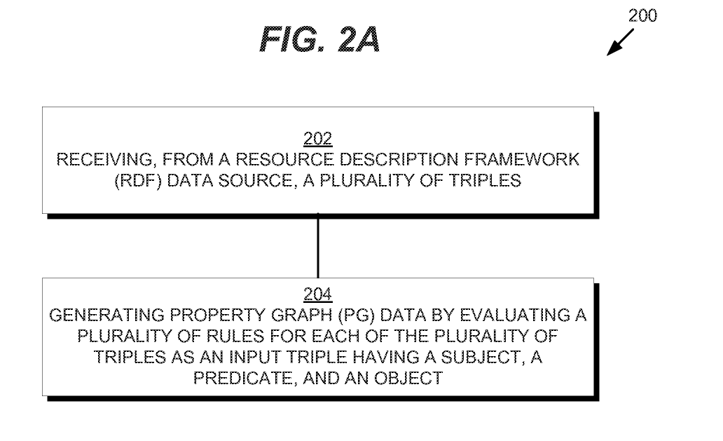

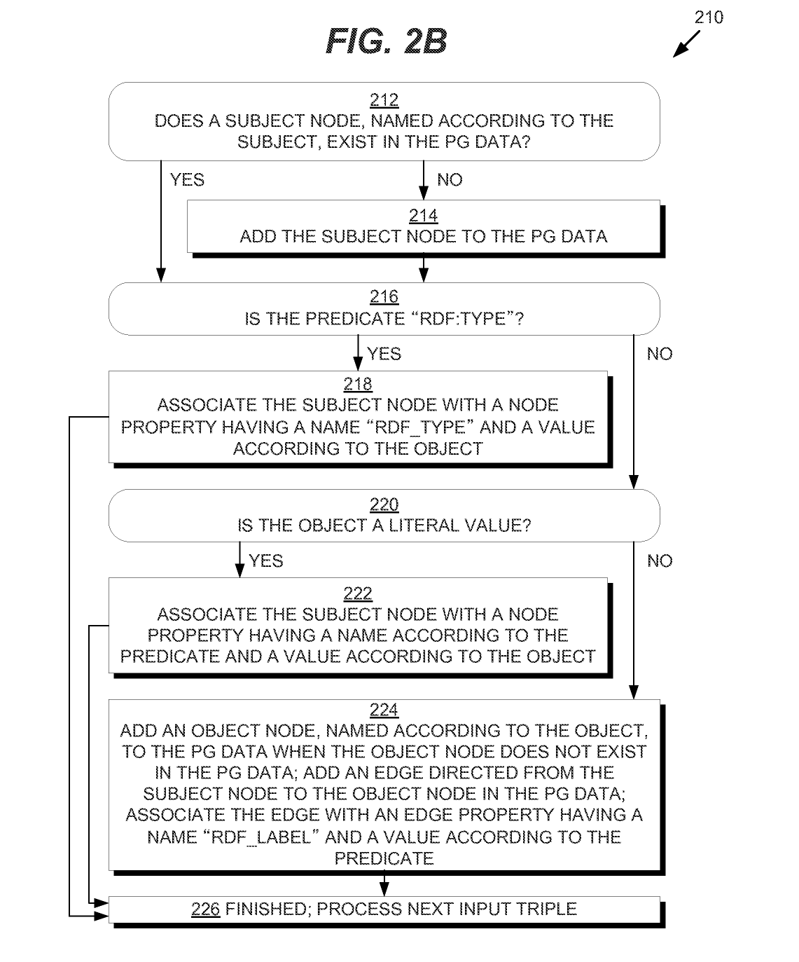

With a basic outline of system 100 now in place, it may be instructive to review a high level overview of the processing steps to utilize graph data processing system 142. Turning to FIG. 2A, FIG. 2A is a block diagram that depicts a process for automatic data model conversion from RDF to PG, according to an embodiment.

### Receiving the RDF Triples

At block 202 of process 200, referring to FIG. 1, server node 120 receives triples 162 from RDF data source 160. For example, graph data processing system 142 may receive triples 162 as serialized RDF/XML data streamed from RDF data source 160, or by another retrieval method or serialization format.

### Generating the PG Data

At block 204 of process 200, referring to FIG. 1, server node 120 generates PG data 180 by evaluating a plurality of rules for each of triples 162 as input triple 164 having a subject 165, a predicate 166, and an object 167. More specifically, the plurality of rules create a subject node, if necessary, and further categorize input triple 164 into three different cases depending on whether or not predicate 166 is “rdf:type” and whether or not object 167 is a literal value. Based on the particular case that input triple 164 falls under, appropriate graph entities 182 are created to generate Property Graph data 180. A more detailed description of these rules is provided in conjunction with FIG. 2B below.

### Rules for Automatic Conversion

FIG. 2B is a block diagram that depicts a plurality of rules for automatic data model conversion from RDF to PG, according to an embodiment. Process 210 of FIG. 2B may correspond to evaluating the plurality of rules described in block 204 of FIG. 2A.

### Creating a Subject Node

Beginning with block 212 of process 210 and referring to FIG. 1, a determination is made of whether a subject node, named according to subject 165, exists in PG data 180. If the subject node does not exist, then it is added to PG data 180, as shown in block 214, and process 210 continues to block 216. If the subject node already exists, then process 210 continues to block 216.

For example, assume that input triple 164 is “tulip rdf:type flower”. Note that for brevity, the URI prefixes are omitted from this example triple. In this case, subject 165 is “tulip”. If a node named “tulip” does not exist in PG data 180, then a node named “tulip” is created and added to PG data 180 in block 214. Otherwise, the “tulip” node already exists and process 210 continues directly to block 216.

### First Case: Predicate is RDF:Type

At block 216 of process 210, referring to FIG. 1, a determination is made whether predicate 166 is “rdf:type”. As described in the RDF Schema (available from http://www.w3.org/RDF/), “rdf:type” is used to state that a resource is an instance of a class. Thus, for example, the triple “tulip rdf:type flower” specifies that the “tulip” resource is an instance of the “flower” class. In some database management systems, “rdf:type” may be abbreviated to “is”, in which case input triple 164 may be read as “tulip is [a] flower”. If a determination is made that predicate 166 is “rdf:type”, then process 210 continues to block 218 as being categorized under a first case; otherwise, process 210 continues to block 220.

At block 218 of process 210, referring to FIG. 1, the subject node in PG data 180 is associated with a node property having the name “rdf_type” and a value according to object 167. Note that a reserved name “rdf_type” is arbitrarily chosen as an example. However, any reserved name can be given in response to determining that predicate 166 is “rdf:type”, such as “rdftype” or “rdf-type”. Thus, continuing with the “tulip rdf:type flower” example, a node property named “rdf_type” with the value “flower” is associated with the “tulip” node in PG data 180, for example by adding an appropriate key-value mapping in graph entities 182. Processing for input triple 164 is therefore finished and process 210 skips to block 226. Note that in this first case, no object node or edge is created, but only a property on the subject node. Thus, the size of the PG data 180 can be minimized for optimal query performance.

### Second Case: Object is a Literal Value

At block 220 of process 210, referring to FIG. 1, a determination is made of whether object 167 is a literal value. For example, if input triple 164 is “John age 20”, then object 167 may correspond to a literal value “20”. If a determination is made that object 167 is a literal value, then process 210 continues to block 222 as being categorized under a second case; otherwise, process 210 continues to block 224 as being categorized under a third case.

At block 222 of process 210, referring to FIG. 1, the subject node is associated with a node property having a name according to predicate 166 and a value according to object 167. Thus, continuing with the “John age 20” example, the node “John” in PG data 180 is associated with a node property “age” that has a value of “20”. Processing for input triple 164 is therefore finished and process 210 skips to block 226. Note that similar to the first case, no object node or edge is created in the second case.

### Third Case: Object is a URI or Blank Node

At block 224 of process 210, referring to FIG. 1, an object node, named according to object 167, is added to PG data 180 when the object node does not exist in PG data 180. Additionally, an edge directed from the subject node to the object node is created in PG data 180, and the edge is associated with an edge property having a name of “rdf_label” and a value according to predicate 166.

If process 210 has reached block 224, then input triple 164 can be categorized under the third case, wherein object 167 is either a URI or a blank node. For example, assume that input triple 164 is “John employee [of] Oracle”. In this case, object 167 may correspond to the URI “Oracle”. If a node named “Oracle” does not already exist in PG data 180, it is created and added to PG data 180. Additionally, an edge directed from the “John” node to the “Oracle” node is created in PG data 180, and the edge is associated with an edge property having a name of “rdf_label” and a value of “employee”. Thus, graph entities 182 may include the “John” subject node from block 214, the “Oracle” object node from block 224, and the edge from block 224 that links the “John” subject node to the “Oracle” object node, wherein the edge has the key-value pair mapping “rdf_label” to “employee”. If object 167 was a blank node instead of a URI, then a unique identifier may be used to name and identify the object node.

Thus, as shown in process 210, once input triple 164 is categorized as falling under one of the three different cases, then an appropriate processing block is executed and process 210 skips to block 226. Process 210 may repeat for the next input triple 164 until RDF data source 160 is exhausted of triples 162, thereby automatically converting RDF data source 160 to PG data 180.

### User Defined Rules

While process 210 as described in FIG. 2B is sufficient for automatic conversion by automatic RDF to PG converter 144, some applications may require a more flexible conversion process. In this case, the administrator may optionally specify one or more user defined rules 146 to modify or override the behavior of the default automatic conversion rules for each input triple 164.

An example syntax for user defined rules 146 is provide as follows:
“predicate”=>“action”,
wherein “predicate” indicates the specific predicate type for predicate 166 to trigger the rule, and
wherein “action” defines an action including {AUTO, EDGE, IGNORE, <type1>, <type2>, . . . }.
   “AUTO” results in the corresponding automatic rule to be applied, as described in process 210.
   “EDGE” results in input triple 164 being converted into an edge from the node corresponding to subject 165 to the node corresponding to object 167 (with the nodes created as necessary). The edge is also associated with the edge property key-value pair mapping of “rdf_label” to predicate 166.
   “IGNORE” results in input triple 164 being skipped and not creating any graph entities.
   <type1>, <type2>, . . . results in input triple 164 being converted into a node property with the specified type. The node property is associated with the node according to subject 165, the name of the node property is according to predicate 166, and the value of the node property is according to object 167.

Prior to processing an input triple 164, the rules in user defined rules 146 are evaluated to determine whether any of user defined rules 146 apply for input triple 164. If so, then the appropriate user defined rule 146 is applied rather than the default automatic rule. Otherwise, input triple 164 is processed as usual using the automatic rules as described above in process 210.

### Hardware Summary

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

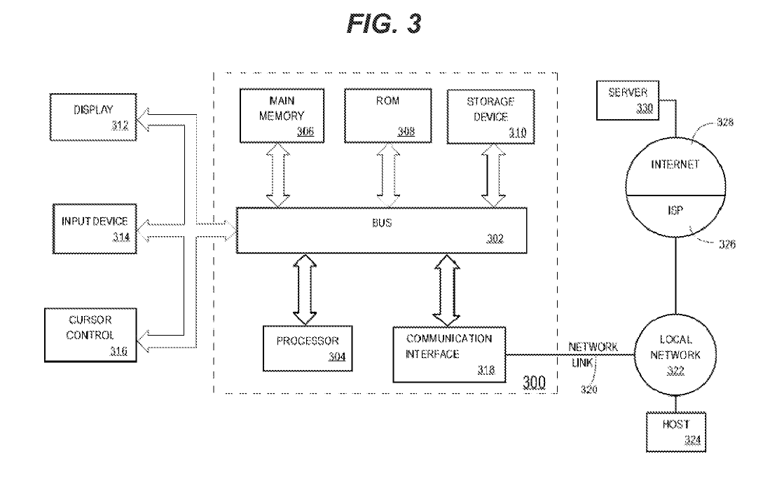

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
receiving, from a Resource Description Framework (RDF) data source, a plurality of triples;
generating Property Graph (PG) data by evaluating a plurality of rules for each of the plurality of triples as an input triple having a subject, a predicate, and an object, wherein the plurality of rules include:
upon determining that a subject node, named according to the subject, does not exist in the PG data, adding the subject node to the PG data; and
upon determining that the predicate is “rdf:type”, associating the subject node with a first node property having a first value according to the object, wherein the associating does not add an object node, named according to the object, to the PG data; and
wherein the method is performed by one or more computing devices.

2. The method of claim 1, wherein the first node property is named using a reserved name in response to determining that the predicate is “rdf:type”.

3. The method of claim 1, wherein the plurality of rules further include:
upon determining that the predicate is not “rdf:type” and the object is a literal value, associating the subject node with a second node property having a second name according to the predicate and a second value according to the object, wherein the associating does not add the object node to the PG data.

4. The method of claim 1, wherein the plurality of rules further include:
upon determining that the predicate is not “rdf:type” and the object is not a literal value, adding the object node to the PG data when the object node does not exist in the PG data, adding an edge directed from the subject node to the object node in the PG data, and associating the edge with an edge property having a third value according to the predicate.

5. The method of claim 1, wherein the evaluating of the plurality of rules for the input triple is in response to determining that one or more user defined rules do not apply for the input triple.

6. The method of claim 5, wherein the one or more user defined rules include a rule that triggers based on the predicate matching to a predicate type specified in the rule.

7. The method of claim 5, wherein the one or more user defined rules include a rule that carries out an action selected from automatic processing, creating an edge, ignoring the input triple, and creating a node property on the subject node.

8. A non-transitory computer-readable medium storing one or more sequences of instructions which, when executed by one or more processors, cause performing of:
receiving, from a Resource Description Framework (RDF) data source, a plurality of triples; and
generating Property Graph (PG) data by evaluating a plurality of rules for each of the plurality of triples as an input triple having a subject, a predicate, and an object, wherein the plurality of rules include:
upon determining that a subject node, named according to the subject, does not exist in the PG data, adding the subject node to the PG data; and
upon determining that the predicate is “rdf:type”, associating the subject node with a first node property having a first value according to the object, wherein the associating does not add an object node, named according to the object, to the PG data.

9. The non-transitory computer-readable medium of claim 8, wherein the first node property is named using a reserved name in response to determining that the predicate is “rdf:type”.

10. The non-transitory computer-readable medium of claim 8, wherein the plurality of rules further include:
upon determining that the predicate is not “rdf:type” and the object is a literal value, associating the subject node with a second node property having a second name according to the predicate and a second value according to the object, wherein the associating does not add the object node to the PG data.

11. The non-transitory computer-readable medium of claim 8, wherein the plurality of rules further include:
upon determining that the predicate is not “rdf:type” and the object is not a literal value, adding the object node to the PG data when the object node does not exist in the PG data, adding an edge directed from the subject node to the object node in the PG data, and associating the edge with an edge property having a third value according to the predicate.

12. The non-transitory computer-readable medium of claim 8, wherein the evaluating of the plurality of rules for the input triple is in response to determining that one or more user defined rules do not apply for the input triple.

13. The non-transitory computer-readable medium of claim 12, wherein the one or more user defined rules include a rule that triggers based on the predicate matching to a predicate type specified in the rule.

14. The non-transitory computer-readable medium of claim 12, wherein the one or more user defined rules include a rule that carries out an action selected from automatic processing, creating an edge, ignoring the input triple, and creating a node property on the subject node.

15. A system comprising one or more computing devices configured to:
receive, from a Resource Description Framework (RDF) data source, a plurality of triples; and
generate Property Graph (PG) data by evaluating a plurality of rules for each of the plurality of triples as an input triple having a subject, a predicate, and an object, wherein the plurality of rules include:
upon determining that a subject node, named according to the subject, does not exist in the PG data, adding the subject node to the PG data; and
upon determining that the predicate is “rdf:type”, associating the subject node with a first node property having a first value according to the object, wherein the associating does not add an object node, named according to the object, to the PG data.

16. The system of claim 15, wherein the first node property is named using a reserved name in response to determining that the predicate is “rdf:type”.

17. The system of claim 15, wherein the plurality of rules further include:
upon determining that the predicate is not “rdf:type” and the object is a literal value, associating the subject node with a second node property having a second name according to the predicate and a second value according to the object, wherein the associating does not add the object node to the PG data.

18. The system of claim 15, wherein the plurality of rules further include:
upon determining that the predicate is not “rdf:type” and the object is not a literal value, adding the object node to the PG data when the object node does not exist in the PG data, adding an edge directed from the subject node to the object node in the PG data, and associating the edge with an edge property having a third value according to the predicate.

19. The system of claim 15, wherein the evaluating of the plurality of rules for the input triple is in response to determining that one or more user defined rules do not apply for the input triple.

20. The system of claim 19, wherein the one or more user defined rules include a rule that triggers based on the predicate matching to a predicate type specified in the rule, wherein the rule carries out an action selected from automatic processing, creating an edge, ignoring the input triple, and creating a node property on the subject node.
